(19) United States
(12) Patent Application Publication
(10) Pub. No.: US 2022/0204879 A1
(43) Pub. Date: Jun. 30, 2022

(54) REDUCING CARBON EMISSIONS ASSOCIATED WITH WASTE GAS

(71) Applicant: ExxonMobile Research and Engineering Company, Annandale, NJ (US)

(72) Inventors: Kevin B. Daly, Jersey City, NJ (US); Mohsen N. Harandi, New Hope, PA (US); Everett J. O'Neal, Asbury, NJ (US); P. Scott Northrop, Spring, TX (US); Narasimhan Sundaram, Annandale, NJ (US); David L. Stern, Madison, NJ (US)

(21) Appl. No.: 17/133,831

(22) Filed: Dec. 24, 2020

(51) Int. Cl. C10J 3/46; C10L 3/10; C10G 49/18; C10J 3/48

(52) U.S. Cl. CPC C10J 3/466; C10L 3/103; C10L 3/104; C10G 49/18; C10J 2300/1846; C10J 2300/0976; C10J 2300/0903; C10G 2300/4043; C10J 2300/0956; C10J 3/48

(57) ABSTRACT

Methods of the present disclosure may comprise: introducing a first effluent and a second effluent in a gasifier of a partial oxidation unit to produce a waste gas, wherein the first effluent comprises one or more hydrocarbon containing feeds and the second effluent comprises air, enriched air with oxygen or oxygen; selectively removing hydrogen sulfide (H₂S) from the waste gas; combining the waste gas and steam in a water-gas shift unit to produce a shift gas comprising hydrogen and carbon dioxide; separating the carbon dioxide from the shift gas in a carbon capture unit to produce a carbon dioxide-enriched effluent and an effluent comprising a hydrogen- and nitrogen-enriched mixture; and recovering the carbon dioxide from the carbon dioxide-enriched effluent.

### FIELD OF THE INVENTION

The present disclosure relates to methods and systems for reducing carbon emissions from waste gas produced from partial oxidation, such as syngas produced from a FLEXICOKING™ process.

### BACKGROUND OF THE INVENTION

Waste gas from a petrochemical facility may be generally described as a gas containing CO and may further include additional components such as hydrogen, methane, carbon dioxide (CO₂), hydrogen sulfide (H₂S), carbonyl sulfide (COS), water, and nitrogen. Depending on the source of the waste gas, the relative concentration of each gas and other gases therein (e.g., hydrogen, nitrogen, sulfur, water, and/or C₁-C₄ hydrocarbons) depends on the process by which the waste gas was produced. Such waste gases are generally burned to produce energy.

The FLEXICOKING™ process was developed by Exxon Research and Engineering Company and is a variant of the Fluid Coking process that is operated in a unit including a reactor and a heater, but also including a gasifier for gasifying the coke product by reaction with an air/steam mixture to form a low heating value fuel gas. A stream of coke passes from the heater to the gasifier where all but a small fraction of the coke is gasified to a low-Btu gas (about 120 Btu/standard cubic feet) by the addition of steam and air in a fluidized bed in an oxygen-deficient environment. Waste gas from a FLEXICOKING™ process is known as syngas, which is a mixture of gases comprising primarily hydrogen, carbon monoxide, carbon dioxide, and nitrogen.

The FLEXICOKING™ process is described in patents of Exxon Research and Engineering Company, including, for example, U.S. Pat. No. 3,661,543 (Saxton), U.S. Pat. No. 3,759,676 (Lahn), U.S. Pat. No. 3,816,084 (Moser), U.S. Pat. No. 3,702,516 (Luckenbach), U.S. Pat. No. 4,269,696 (Metrailer). A variant is described in U.S. Pat. No. 4,213,848 (Saxton) in which the heat requirement of the reactor coking zone is satisfied by introducing a stream of light hydrocarbons from the product fractionator into the reactor instead of the stream of hot coke particles from the heater. Another variant is described in U.S. Pat. No. 5,472,596 (Kerby) using a stream of light paraffins injected into the hot coke return line to generate olefins.

Combustion of waste gases associated with Flexicoker can account for 15-70% of a refinery's CO₂ emissions and it is desirable to reduce such emissions.

### SUMMARY OF THE INVENTION

The present disclosure relates to methods and systems for reducing carbon emissions from waste gas produced from partial oxidation, such as syngas produced from a FLEXICOKING™ process.

Methods of the present disclosure may comprise: introducing a first effluent and a second effluent in a gasifier of a partial oxidation unit to produce a waste gas, wherein the first effluent comprises one or more hydrocarbon containing feeds and the second effluent comprises air, enriched air with oxygen or oxygen; selectively removing hydrogen sulfide (H₂S) from the waste gas; combining the waste gas and steam in a water-gas shift unit to produce a shift gas comprising hydrogen and carbon dioxide; separating the carbon dioxide from the shift gas in a carbon capture unit to produce a carbon dioxide-enriched effluent and an effluent comprising a hydrogen- and nitrogen-enriched mixture; and recovering the carbon dioxide from the carbon dioxide-enriched effluent.

A facility of the present disclosure for reducing carbon emissions from waste gas produced from partial oxidation may comprise: at least one partial oxidation unit comprising one or more gasifiers configured for producing a waste gas and heat from one or more feeds, in presence of air and/or oxygen; a water-gas shift unit configured to receive the waste gas and steam for producing a shift gas comprising hydrogen and carbon dioxide; a carbon capture unit configured to receive the shift gas for at least partially removing the carbon dioxide from the shift gas and for producing a carbon dioxide-enriched gas and an effluent comprising a hydrogen- and nitrogen-enriched mixture.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a non-limiting example flow diagram of a method for reducing carbon emissions from waste gas.

FIG. 2 is another non-limiting example flow diagram of a method for reducing carbon emissions from waste gas produced from partial oxidation.

FIG. 3 is a non-limiting example flow diagram of a method for reducing carbon emissions including a reverse carbonate fuel cell.

FIG. 4 is another non-limiting example flow diagram of a method for reducing carbon emissions from waste gas produced from partial oxidation and further blended with various refinery carbon dioxide-rich streams.

FIG. 5 is a non-limiting example flow diagram of a method for reducing carbon emissions from waste gas produced from partial oxidation with particulate matters removal.

FIG. 6 is a non-limiting example flow diagram of a method for reducing carbon emissions from waste gas produced from partial oxidation occuring in a gasifier of a Flexicoker, and for producing ammonia and/or urea, with particulate matters removal.

### DETAILED DESCRIPTION OF THE INVENTION

The present disclosure relates to methods and systems for reducing carbon emissions from waste gas produced from partial oxidation, such as syngas produced from a FLEXICOKING™ process.

Waste gas is created from a partial oxidation of various feeds and comprises a gas or mix of gases containing CO and optionally, hydrogen, methane, carbon dioxide, hydrogen sulfide (H₂S), carbonyl sulfide (COS), water, and nitrogen. The waste gas may begin as any of a number of known feeds, such as methane, biomass, residue streams from a petrochemical process, etc. Moreover, the partial oxidation itself may be of any form. Some example partial oxidation processes include catalytic process (such as autothermal reforming technology available from Haldor Topsoe headquartered in Lyngby, Denmark) or a non-catalytic, heat-based process (such as the flexicoke process developed by Exxon Research and Engineering Company). The waste gas resulting from partial oxidation is a gas mixture consisting primarily of hydrogen, carbon monoxide, and may include carbon dioxide or nitrogen.

Generally, the methods discussed herein describe processing a hydrocarbon stream in a partial oxidation reactor in the presence of air or oxygen, wherein an output of the partial oxidation reactor is a waste gas. In some cases, the partial oxidation reactor may be a FLEXICOKING™ process, in which case the waste gas generally referred to as a FLEXIGAS™ also referred to herein as FLEXICOKING™ syngas. The waste gas is then processed to perform a water-gas shift (WGS) reaction. In some cases the WGS reaction and the removal of carbon dioxide from the waste gas is performed in series, and in other cases the two processes are performed simultaneously. The WGS reactor and removal of carbon dioxide, often referred to a carbon capture, will first generally be discussed in series. In at least one embodiment, methods of the present disclosure comprise: removing carbon dioxide from the shift gas to produce a hydrogen-enriched shift gas using two different separation technologies in series as a two-step process (as described above).

A WGS reactor reacts carbon monoxide and water vapor to form carbon dioxide and hydrogen: CO+H₂O↔CO₂+H₂. The WGS reaction is performed in the presence of a WGS catalyst under effective conditions. A WGS catalyst is generally a metal catalyst, such as an iron oxide, a combination of zinc oxide and aluminum oxide, or one or more transition metal oxides. A range of temperatures can be used for a WGS reaction, but depending on the type of catalyst, the temperature for the WGS reaction generally can be from about 190° C. to about 425° C. The reaction is generally exothermic, so increasing temperatures can tend to favor production of CO and H₂O. The WGS reaction can be driven toward production of additional hydrogen by introducing an excess of steam into the process. Prior combination of the waste gas with steam, hydrogen sulfide can be selectively removed.

In some cases, the output from the WGS reactor may have a H₂ content as high as about 80 vol % or as low as about 20 vol % (or from about 25 vol % to about 75 vol %, or from about 30 vol % to about 70 vol %, or from about 35 vol % to about 65 vol %, or from about 40 vol % to about 60 vol %, or from about 20 vol % to about 60 vol %). Moreover, the output from the WGS reactor may have a CO₂ content as high as about 40 vol % or as low as about 5 vol % (or from about 10 vol % to about 35 vol %, or from about 15 vol % to about 30 vol %, or from about 20 vol % to about 25 vol %, or from about 5 vol % to about 25 vol %, or from about 5 vol % to about 20 vol %).

The gas leaving the WGS reactor is known as a shift gas, and comprises primarily CO₂ and H₂. The shift gas is then sent to a carbon capture system to separate and recover the CO₂ from the shift gas. The carbon capture system creates a CO₂ stream and a stream comprising H₂ and N₂.

A variety of techniques are available for recovering CO₂ from the shift stream. One option for recovering CO₂ can involve passing the effluent through an adsorbent system, such as an amine adsorbent system. Suitable amines can include piperazines and/or ethanolamines. Various known/conventional methods for using amines to extract CO₂ can be used in conjunction with the systems and methods of the present disclosure. Typically, O₂ in flue gas is known to react with some common amines such as ethanolamine (MEA) to form NH₃, leading to amine loss and equipment corrosion. In contrast, absence (or at least negligible presence) of O₂ during partial oxidation and WGS processes of the present disclosure advantageously prevents any potential degradation of the carbon capture adsorbent system.

One example of a system for recovering CO₂ from the shift stream can be to use a pair of columns. A first column can be set up for effective contacting of a gas phase effluent with a solvent/absorbent for the CO₂. The gas phase effluent can advantageously be passed through the column in a counter-current manner relative to the CO₂ absorbent. The output from the first column can thus be a gas phase product with a reduced CO₂ content and typically a liquid absorbent with an increased CO₂ content. Optionally, the column can include contacting elements to increase the interaction between the gas flow and the liquid absorbent within the column. The contacting elements can be, for example, trays or packing material. Optionally, a wash region can be included at the top of the column to remove any absorbent that becomes entrained in the gas phase flow.

The second column can advantageously be used to regenerate the absorbent, resulting in a product stream containing at least the extracted CO₂. In the second column, the liquid absorbent containing the CO₂ can be passed down through the second column. The second column may also contain contacting elements. The pressure in the second column can be lower than the first column, resulting in some release of the CO₂ due the lower pressure. CO₂ remaining in the absorbent at the bottom of the column can be removed by heating the absorbent. This can result in action similar to a distillation column, where the absorbent and CO₂ can form a vapor that can travel up in the column. As the vapor cools, the absorbent can fall back down in the column as a liquid, leaving behind the gas phase CO₂. A CO₂ stream (e.g., carbon dioxide-enriched effluent can be removed from the top of the second column.

By using an amine unit (or another type of CO₂ recovery process), an input stream having a CO₂ content can be separated to form a CO₂ recovery stream and a hydrogen-enriched stream. The (output) CO₂ recovery stream can include at least about 65 vol % of the CO₂ content from the input stream, for example at least about 70 vol %, at least about 75 vol %, at least about 80 vol %, or at least about 85 vol %, based on the total volume of the CO2 recovery stream (e.g., carbon dioxide-enriched effluent.

Advantageously, methods of the present disclosure enable centralizing in a single location the CO₂ capture and without the need for ductwork to combine large volumes of gases (e.g., flue gas) from individual furnace stacks. Further, existing fuel gas headers can be used to distribute low carbon fuel gases. Methods of the present disclosure also provide lower CAPEX/OPEX for the carbon capture process. Additionally, benefit of combining partial oxidation with air, WGS, and carbon capture to produce a mixture of H₂/N₂ fuel gas is that N₂ can act as a diluent to prevent excessive flame temperatures in burners. For many conventional syngas processes, partial oxidation with air is not economical because it increases the size of downstream equipment (e.g., methanol production from natural gas). However, in the present disclosure, the N₂ diluent is an advantage in the final product. Moreover, low pressure H₂/N₂, generally considered a low value stream, is produce in order to reduce the CO₂ footprint of the refinery.

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature) is from about 18° C. to about 20° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

Where the term “between” is used herein to refer to ranges, the term encompasses the endpoints of the range. That is, “between 2% and 10%” refers to 2%, 10% and all percentages between those terms.

Numerical ranges used herein include the numbers recited in the range. For example, the numerical range “from 1 wt % to 10 wt %” includes 1 wt % and 10 wt % within the recited range and all points within the range.

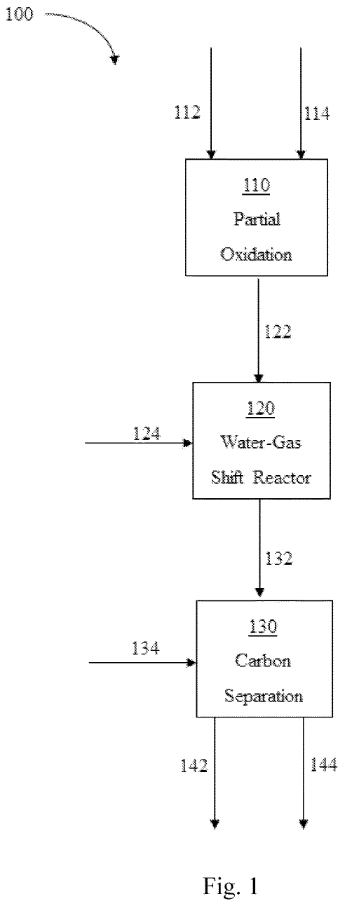

FIG. 1 illustrates a diagram of a non-limiting example method 100 that acts to separate to at least a portion of the carbon monoxide present in the waste gas from a partial oxidation reaction.

In method 100 the WGS reaction and the removal of carbon monoxide from the waste gas is performed in series. In this non-limiting example of method 100, a first effluent 112 comprising one or more hydrocarbon containing feeds, and a second effluent 114 comprising air, enriched air with oxygen, or oxygen are introduced in a gasifier of a partial oxidation unit 110 to produce a waste gas 122. The one or more feeds may comprise a gas selected from the group consisting of: CO; hydrogen; methane; carbon dioxide; carbonyl sulfide; hydrogen sulfide; water; nitrogen; biomass; plastics; petroleum coke; coal; resid; C₁-C₄ hydrocarbons; and any combination thereof. The gasifier of the partial oxidation unit 110 may be configured to increase the production of hydrogen per coke burned, wherein the amount of hydrogen increases with the amount of methane brought in. Waste gas 122 is then sent to a WGS reactor 120. The WGS reactor 120 reacts carbon monoxide and water vapor to form carbon dioxide and hydrogen: CO+H₂O↔CO₂+H₂. The WGS reaction is performed in the presence of a WGS catalyst under effective conditions. A WGS catalyst is generally a metal catalyst, such as an iron oxide, a combination of zinc oxide and aluminum oxide, or one or more transition metal oxides. A range of temperatures can be used for a WGS reaction, but depending on the type of catalyst, the temperature for the WGS reaction generally can be from about 190° C. to about 425° C. The reaction is generally exothermic, so increasing temperatures can tend to favor production of CO and H₂O. The WGS reaction can be driven toward production of additional hydrogen by introducing an excess of steam 124 into the process. Prior combination of the waste gas with steam, hydrogen sulfide can be selectively removed.

In some cases, the output from the WGS reactor 120 may have a H₂ content as high as about 80 vol % or as low as about 20 vol % (or from about 25 vol % to about 75 vol %, or from about 30 vol % to about 70 vol %, or from about 35 vol % to about 65 vol %, or from about 40 vol % to about 60 vol %, or from about 20 vol % to about 60 vol %). Moreover, the output from the WGS reactor 120 may have a CO₂ content as high as about 40 vol % or as low as about 5 vol % (or from about 10 vol % to about 35 vol %, or from about 15 vol % to about 30 vol %, or from about 20 vol % to about 25 vol %, or from about 5 vol % to about 25 vol %, or from about 5 vol % to about 20 vol %).

The WGS reactor 120 produces shift gas 132 that includes primarily CO₂ and H₂. The shift gas 132 is then sent to a carbon capture system 130 to separate and recover the CO₂ from the shift gas 132. The carbon capture system 130 produces a carbon dioxide-enriched effluent 144 comprising CO₂ and an effluent 142 comprising a mixture of H₂ and N₂. An excess of steam 134 can be introduced into the carbon capture system 130. Steam 134 can be generated from the heat produced in partial oxidation unit 110. Said heat recovered from the partial oxidation process (e.g., through a waste heat boiler) can be used to generate steam 124 for WGS reaction and/or steam 134 for the carbon capture process. For example, steam 124 could be fed directly to WGS reactor 120 or upstream to partial oxidation unit 110 to help control flame temperature and product distribution. Further, the partial oxidation process may also include a partial nitrogen removal from the air stream 114 in order to remove a significant fraction (about 25% to 50%) of the nitrogen content for the purpose of avoiding downstream bottlenecks (e.g., pressure drop) in an existing piping infrastructure.

Effluent 142 comprising the mixture of H₂ and N₂ can be burned with or without assistance of added fuel gas (e.g., methane). Effluent 142 comprising the mixture of H₂ and N₂ may be sent directly to a fuel gas header (not shown). The mixture could be made at high pressure, however only low pressure (e.g., about 3 bara or less, or about 2.5 bara or less, or about 2 bara or less, or about 1.5 bara or less) may be suitable for the fuel gas header. In at least one embodiment, methods of the present disclosure comprise: processing the effluent comprising the hydrogen- and nitrogen-enriched mixture in one or more refinery fuel gas headers, wherein the effluent can optionally be combined with one or more fuel gases.

In some cases, nitrogen from air of the second effluent 114 may be at least partially removed.

Recovery of CO₂ from the shift gas 132 may be achieved using suitable recovering techniques as described further. Methods of the present disclosure advantageously produce CO₂ on-site. Said CO₂ can be sequestered, stored, or used for Enhanced Oil Recovery (EOR), which would enable increasing the oil production of onshore and of the nearby offshore sites, exploration and production facilities. Additionally, methods of the present disclosure include ammonia and urea production capabilities.

One option for recovering CO₂ can involve passing the effluent shift gas 132 through an absorbent system, such as an amine absorbent system. Suitable amines can include piperazines and/or ethanolamines. Various known/conventional methods for using amines to extract CO₂ can be used in conjunction with the inventive systems and methods described herein.

One example of a system for recovering CO₂ from the stream shift gas 132 can be to use a pair of columns. A first column can be set up for effective contacting of shift gas 132 with a solvent/absorbent for the CO₂. The shift gas 132 can advantageously be passed through the column in a counter-current manner relative to the CO₂ absorbent. The output from the first column can thus be a gas phase product with a reduced CO₂ content and typically a liquid absorbent with an increased CO₂ content. Optionally, the column can include contacting elements to increase the interaction between the gas flow and the liquid absorbent within the column. The contacting elements can be, for example, trays or packing material. Optionally, a wash region can be included at the top of the column to remove any absorbent that becomes entrained in the gas phase flow.

The second column can advantageously be used to regenerate the absorbent, resulting in the product stream 144 containing at least the extracted CO₂. In the second column, the liquid absorbent containing the CO₂ can be passed down through the second column. The second column may also contain contacting elements. The pressure in the second column can be lower than the first column, resulting in some release of the CO₂ due the lower pressure. CO₂ remaining in the absorbent at the bottom of the column can be removed by heating the absorbent. This can result in action similar to a distillation column, where the absorbent and CO₂ can form a vapor that can travel up in the column. As the vapor cools, the absorbent can fall back down in the column as a liquid, leaving behind the gas phase CO₂. CO₂ stream (e.g., carbon dioxide-enriched 144) can be removed from the top of the second column.

In some cases, carbon capture unit 130 can be an amine unit. By using an amine unit (or any suitable CO₂ recovery process), an input stream having a CO₂ content can be separated to form the CO₂ recovery stream 144 and a hydrogen-enriched stream 142. The (output) CO₂ recovery stream 144 can include at least about 65 vol % of the CO₂ content from the input stream, for example at least about 70 vol %, at least about 75 vol %, at least about 80 vol %, or at least about 85 vol %, based on the total volume of the carbon dioxide-enriched effluent 144.

For example, the carbon dioxide-enriched effluent 144 may have a carbon dioxide content of about 50 vol % or greater, such as a carbon dioxide content of at least about 85 vol %, based on the total volume of the carbon dioxide-enriched effluent 144.

In some cases, partial oxidation reactor 110 may be a FLEXICOKING™ process for converting hydrocarbons in the presence of steam and air into lighter hydrocarbons and FLEXICOKING™ syngas (e.g., FLEXIGAS™). The composition of the syngas produced from the FLEXICOKING™ process can vary but typically has a composition of about 0.5 vol % to about 2 vol % C₁-C₄ hydrocarbons, about 13 vol % to about 18 vol % hydrogen, about 20 vol % to about 26 vol % carbon monoxide, about 4 vol % to about 10 vol % carbon dioxide, about 45 vol % to about 55 vol % nitrogen, and about 1 vol % to about 5 vol % water.

Briefly, the FLEXICOKING™ process, developed by Exxon Research and Engineering Company, is a non-catalytic thermal conversion process where fluid coke produced in the reactor is gasified with process steam and air to produce a higher value fuel gas (e.g., FLEXIGAS™). The process is, in fact, a variant of the Fluid Coking process that is operated in a unit including a cracking reactor and a gasifier for gasifying the coke product by reaction with an air/steam mixture to form a fuel gas. A stream of coke passes to the gasifier where all but a small fraction of the coke is gasified by the addition of steam and air in a fluidized bed in an oxygen-deficient environment at very high temperatures to form a low-Btu fuel gas (about 4800 kJ/kg, about 128 BTU/SCF) comprising carbon monoxide and hydrogen. The fuel gas product from the gasifier, containing entrained coke particles at high temperature, is conventionally returned to an intermediate heater vessel to provide most of the heat required for thermal cracking in the reactor with the balance of the reactor heat requirement supplied by combustion of coke in the heater. A small amount of net coke (about 1% percent of feed) is withdrawn from the heater to purge the system of metals and ash. The liquid yield and properties are comparable to those from Fluid Coking. The FLEXICOKING™ syngas is withdrawn from the heater following separation in internal cyclones, which return coke particles to the bed of hot coke particles in the heater through their diplegs.

The Flexicoker may be a conventional three-vessel unit of cracking reactor, heater, and gasifier or, alternatively, a two-vessel unit of reactor and gasifier in which the coke from the reactor passes directly to the gasifier and hot, partly gasified coke particles from the gasifier are cycled back to the reactor to provide the heat for the endothermic cracking reactions. A unit of this type is described in U.S. Publication No. 2015/0368572, which is incorporated herein by reference.

Corrosion fines and coke particles containing Ni and V may be present during waste gas production. Thus, partial oxidation process (e.g., FLEXICOKING™) and resid gasification may increase particulate matters emissions. Methods of the present disclosure may comprise particulate matters removal, which advantageously enable upgrading waste gas to clean-burning H₂ with sufficient inerts/fuel gas to manage optimum burner performance. Methods for particulate matters removal is described further herein.

Furthermore, methods of the present disclosure may comprise hydrogen sulfide removal to produce a carbon dioxide-enriched effluent. Selective removal of hydrogen sulfide can be performed using, for example, Compact Mass transfer and Inline Separation Technology (cMIST™), SELEXOL® process, FLEXSORB® SE solvents technology, and any combination thereof.

In some cases, the water-gas shift unit and the carbon capture unit may be replaced by a Sorption Enhanced Water-Gas Shift unit.

As will be apparent to those skilled in the art, the methods 100 illustrated in this non-limiting example and related systems may include additional components like compressors, membranes, valves, flow meters, heat exchangers, traps, and the like for proper and safe operation of said methods and systems.

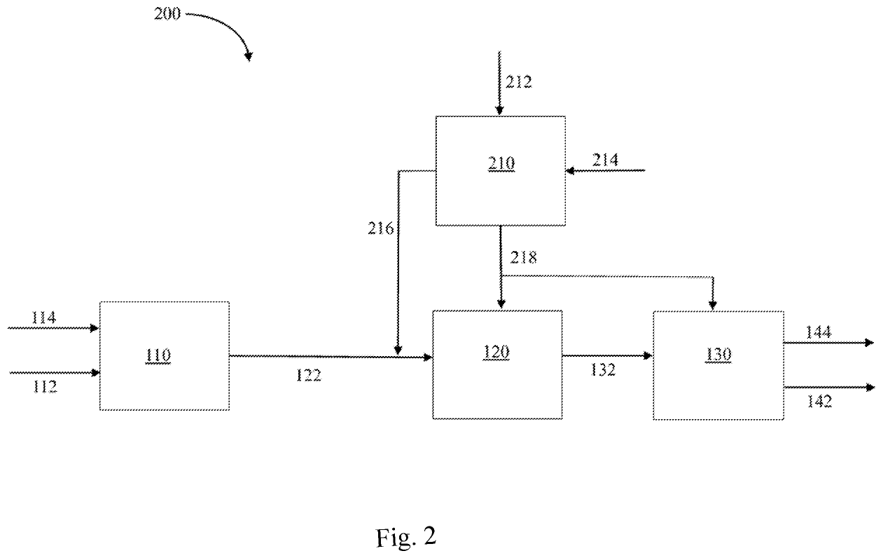

FIG. 2 illustrates a diagram of non-limiting example method 200 that integrates at least two partial oxidation units for reducing carbon emissions from waste gas. In method 200, the WGS reaction and the removal of carbon monoxide from the waste gas is performed in series. In this non-limiting example of method 200, effluent 212 comprising one or more feeds (such as natural gas (NG); CO; hydrogen; methane; carbon dioxide; carbonyl sulfide; hydrogen sulfide; water; nitrogen; biomass; plastics; petroleum coke; coal; resid; C₁-C₄ hydrocarbons; and any combination thereof), and effluent 214 comprising air or oxygen are introduced in a gasifier of a partial oxidation unit 210 to produce a waste gas 216. The gasifier of the partial oxidation unit may be configured to increase the production of hydrogen per coke burned, wherein the amount of hydrogen may increase with the amount of methane brought in. Waste gas 216 is then sent to WGS reactor 120. Steam 218 generated from the heat produced in partial oxidation unit 210 can be introduced into carbon capture system 130. Steam 218 can be fed directly to WGS reactor 120 or upstream to partial oxidation unit 210 to help control flame temperature and product distribution. Prior combination of the waste gas with steam, hydrogen sulfide can be selectively removed.

As will be apparent to those skilled in the art, the methods 200 illustrated in this non-limiting example and related systems may include additional components like compressors, membranes, valves, flow meters, heat exchangers, traps, and the like for proper and safe operation of said methods and systems.

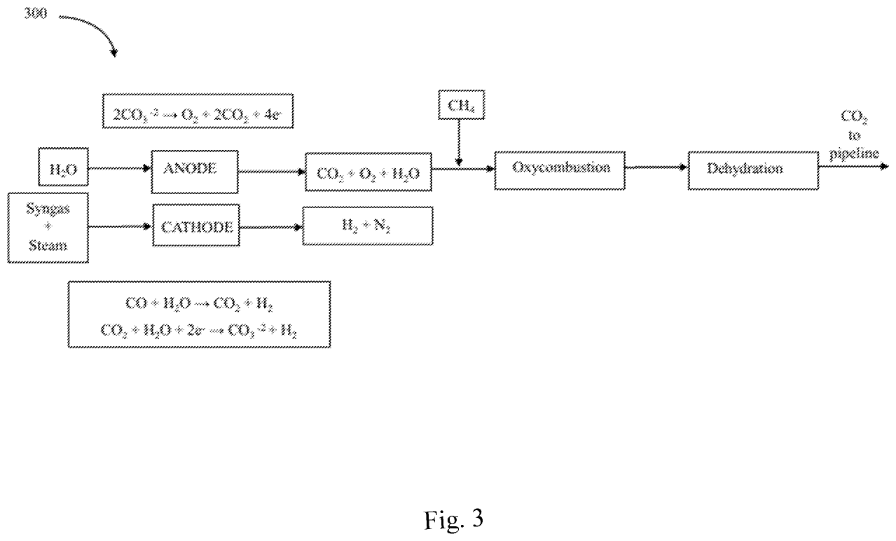

FIG. 3 is a non-limiting example flow diagram of method 300 for reducing carbon emissions, wherein the water-gas shift unit (e.g., water-gas shift unit 120) and the carbon capture unit (e.g., carbon capture unit 130) are both replaced by a carbonate fuel cell operated “in reverse” with power supplied to produce a low pressure product mixture of about 3 bara or less (or about 2.5 bara or less, or about 2 bara or less, or about 1.5 bara or less) comprising a hydrogen- and nitrogen-enriched mixture. On the cathode side, the syngas can be converted to CO₂/H₂ via the water gas shift reaction. Additional H₂ can be produced by splitting water into oxygen and hydrogen, with the oxygen atom combining with CO₂ to form a carbonate anion (CO₃²⁻) that can travel to the anode side of the cell. At the anode, the carbonate can be converted back to oxygen and CO₂. Cathode-side catalyst could be, e.g., nickel, which could perform both the WGS and water-splitting reactions. In addition, other non-limiting types of WGS catalysts (e.g., iron and/or copper oxides) could be included on the cathode side. On the anode side, the catalyst could be, e.g., nickel oxide. Power can be supplied in order to pump electrons from the anode to the cathode. The anode effluent may contain O₂, which can be combusted with methane (CH₄) and then dehydrated to produce CO₂ that can be put in a pipeline for sequestration. The cathode effluent can be used to supply heat to another process with significantly reduced CO₂ emissions compared to waste gas.

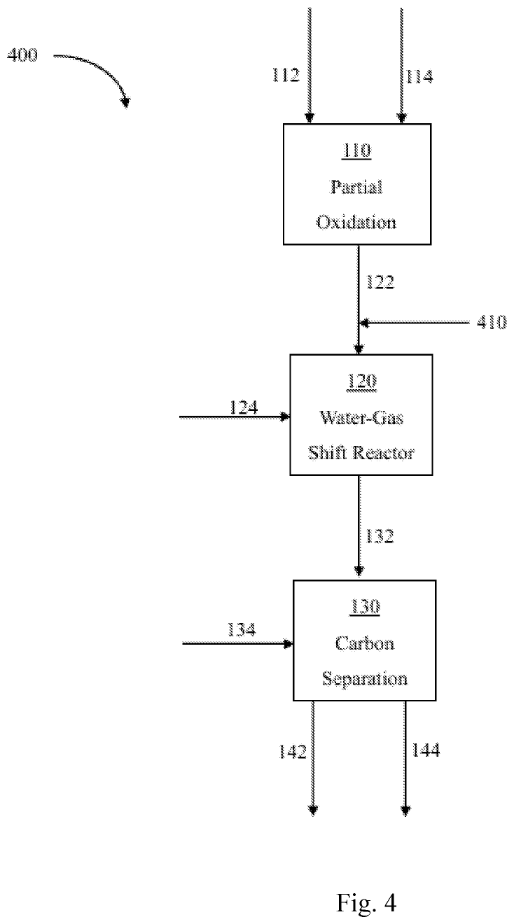

FIG. 4 is a non-limiting example flow diagram of method 400 for reducing carbon emissions from waste gas produced from partial oxidation and further blended with various refinery carbon dioxide-enriched streams 410, such as carbon dioxide-enriched streams produced from H₂ production plant (e.g., tail gas from the Pressure Swing Adsorption step in an H₂ plant)

As will be apparent to those skilled in the art, the methods 400 illustrated in this non-limiting example and related systems may include additional components like compressors, membranes, valves, flow meters, heat exchangers, traps, and the like for proper and safe operation of said methods and systems.

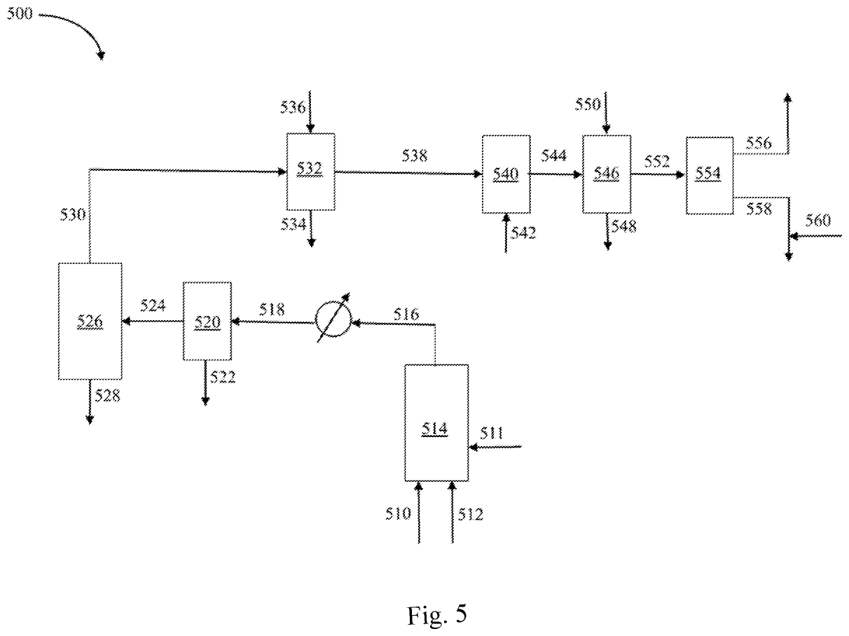

FIG. 5 is a non-limiting example flow diagram of method 500 for reducing carbon emissions from waste gas produced from partial oxidation occuring in a gasifier of a Flexicoker, wherein the waste gas is Flexicoking syngas, thus by implementing a process for particulate matters (e.g., fines) removal. Generally, methods 500 according to the present disclosure may comprise: introducing a first effluent 510 and a second effluent 511 in a gasifier of a partial oxidation unit 514 to produce a waste gas 516, wherein the first effluent 510 comprises one or more feeds (as described above) and the second effluent comprises air or oxygen. A stream of steam 512 can be introduced in the gasifier of the partial oxidation unit 514. Effluent comprising waste gas 516 is then cooled prior to be introduced to an overhead knock out drum 520, wherein condensed water and particulate matters can be recovered (effluent 522), thus to achieve a reduction in particulate content of the waste gas 524. Recovery process of the particulate matters can further be enhanced by using a vessel wherein the drop out is configured for high residence time, and using internals to enhance fines drop-out including water injection to capture more fines.

Further, particulate-free waste gas 524 is introduced into a sulfur treating unit 526 wherein H₂S is selectively removed (effluent 528) to produce a purified waste gas 530 having a sulfur content of about 2 vppm or less (or about 1.5 vppm or less, or about 1 vppm or less). Suitable examples of sulfur treating technology may include, but are not limited to, FLEXSORB® SE or SE Plus solvents technologies (available from ExxonMobil Chemical Company). FLEXSORB® SE and SE Plus solvents technologies provide a cost-effective way to meet low H₂S specifications while minimizing CO₂ co-absorption, and is designed for the selective removal of H₂S in the presence of CO₂. FLEXSORB® SE solvents technology utilizes proprietary severely sterically hindered amines. The unique characteristics of the amine allow it to achieve high H₂S cleanup selectively at low solvent circulation rates.

Additional fines removal can be carried out prior to WGS process. Thus, purified waste gas 530 is introduced in overhead knock out drum 532, wherein a stream of water 536 is also introduced, enabling fines removal (effluent 534 comprising a mixture of water and particulate matters) and production of waste gas 538.

Method 500 further comprises: combining waste gas 538 and steam 542 in a water-gas shift unit 540 to produce a shift gas 544 comprising hydrogen and carbon dioxide. Fines removal from shift gas 544 can be carried out prior to introducing shift gas 544 to carbon capture unit 554. Thus, shift gas 544 is introduced in overhead knock out drum 546, wherein a stream of water 550 is also introduced, enabling fines removal (effluent 548 comprising a mixture of water and particulate matters) and production of purified shift gas 552.

Method 500 further comprises: separating the carbon dioxide and the hydrogen from purified shift gas 552 in carbon capture unit 554 to produce carbon dioxide-enriched effluent 556 and effluent 558 comprising a hydrogen- and nitrogen-enriched mixture.

Said particulate matters removal can be conducted at low pressure of about 100 Psi or less (or 95 psi or less, or 90 psi or less, or 85 psi or less, or 80 psi or less, or 75 psi or less). Alternately, said particulate matters removal can be conducted at moderately high pressure of from about 100 psi to about 1,000 psi (or about 150 psi to about 950 psi, or from about 200 psi to about 900 psi, or about 250 psi to about 850 psi, or about 300 psi to about 800 psi, or about 100 psi to about 500 psi, or about 150 psi to about 450 psi, or about 200 psi to about 400 psi). At higher pressure values (greater than 1,000 psi), weaker amines or solvents can be used (e.g., methyl diethanolamine, Selexol) which enable reducing amine regeneration energy requirements, as well as reducing the piping and shift reactor costs.

As will be apparent to those skilled in the art, the methods 500 illustrated in this non-limiting example and related systems may include additional components like compressors, membranes, valves, flow meters, heat exchangers, traps, and the like for proper and safe operation of said methods and systems.

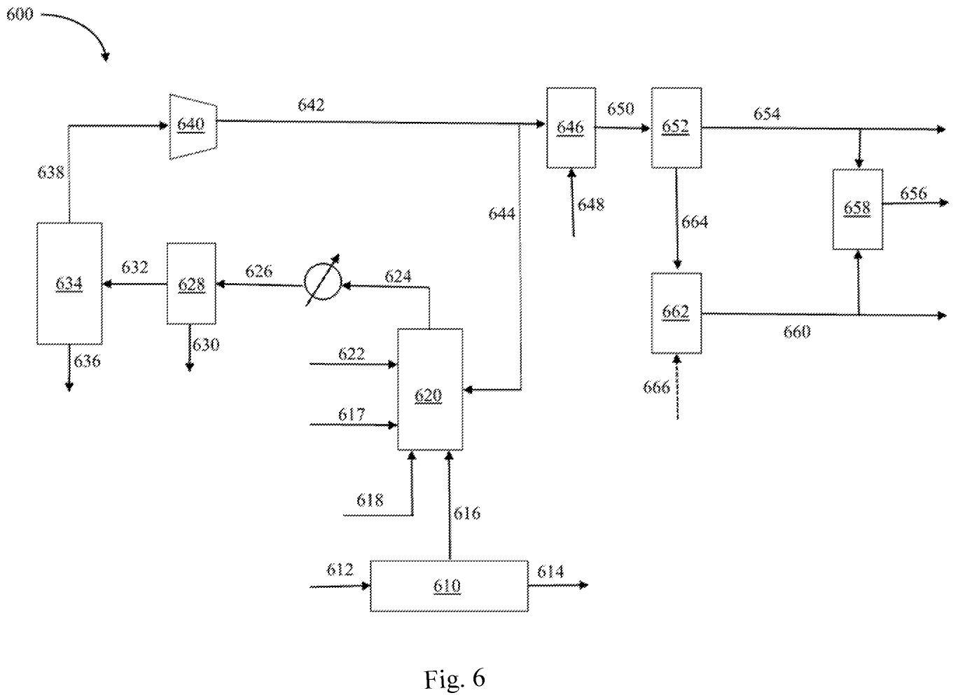

FIG. 6 is a non-limiting example flow diagram of method 600 for carbon emissions reduction (e.g., CO₂ recovery), ammonia and/or urea production, while achieving particulate matters reduction. Method 600 can also be applicable for H₂ production, methanol production and its derivatives (not shown). Method 600 can be achieved by increasing the post-water-gas-shift concentration of H₂ to N₂ to about 3:1 (or about 2:1, or about 2.5:1, or about 1:1, or about 3.5:1, or about 4:1) for production of ammonia. Concentration of H₂ can be increased by maximizing steam injection into the gasifier of the partial oxidation unit, introducing methane (or any suitable fuel gas) into the gasifier of the partial oxidation unit for steam reforming (methane injection to the gasifier can range from 0 wt % to 100 wt % of coke introduced to the gasifier, based on the total weight of coke), shifting CO in a water-gas shift reactor to H₂ and CO₂, and/or removing excess of N₂ either from the air feeding the gasifier of the partial oxidation unit (preferably recycling a portion of the waste gas (e.g., FLEXICOKING™ syngas) by a blower to maintain the gasifier temperature of about 800° C. to about 1,500° C. to prevent slag formation) or from the waste gas (e.g., FLEXICOKING™ syngas) after WGS process and CO₂ recovery. When method 600 is applicable for methanol production (or its derivatives), majority or close to all of N₂ may be removed the air feed introduced to the gasifier of the partial oxidation unit. When method 600 is applicable for H₂ production (e.g., H₂ production for chemical reactions usage such as hydrotreating). H₂ can be either separated from air by Pressure Swing Adsorption (PSA) prior to partial oxidation process, or separated by membrane from N₂ carbon capture process (e.g., after CO₂ removal).

Generally, methods 600 according to the present disclosure may comprise: converting effluent 617 comprising one or more feeds into waste gas 624 in the gasifier of partial oxidation unit 620, thus in presence of steam 616, an oxygen rich feed 618 (instead of air, as described in the preceding methods), and methane (or any suitable fuel gas). The one or more feeds of effluent 617 may comprise a gas selected from the group consisting of: CO; hydrogen; methane; carbon dioxide; carbonyl sulfide; hydrogen sulfide; water; nitrogen; biomass; plastics; petroleum coke; coal; resid; C₁-C₄ hydrocarbons; and any combination thereof. Oxygen rich feed 618 can be produced from partial N₂ separation of air 612 in a partial N₂ separation unit 610, wherein a N₂-enriched effluent 614 is purged out. In at least one embodiment, partial N₂ separation unit 610 may be a membrane or a cryogenic distillation unit.

Effluent comprising waste gas 624 is then cooled (e.g, cooled effluent 626) prior to be introduced to an overhead knock out drum 628, wherein condensed water and particulate matters can be recovered (effluent 630), thus to produce a particulate-free waste gas 632. Recovery process of the particulate matters can further be enhanced by using a vessel wherein the drop out is configured for high residence time, and using internals to enhance fines drop-out including water injection to capture more fines. For example, removal of particulate matters can be enhanced by using a water wash and/or an interstage compressor water condensation.

Further, particulate-free waste gas 632 is introduced into a sulfur treating unit 634 wherein H₂S is selectively removed (effluent 636) to produce a purified waste gas 638 having a sulfur content of about 400 vppm or less (or about 300 vppm or less, or about 200 vppm or less, or about 100 vppm or less, or about 50 vppm or less, or about 25 vppm or less, or about 20 vppm or less, or about 15 vppm or less, or about 10 vppm or less, or about 5 vppm or less, or about 2 vppm or less, or about 1.5 vppm or less, or about 1 vppm or less). Suitable examples of sulfur treating technology may include, but are not limited to, FLEXSORB® SE or SE Plus solvents technologies (available from ExxonMobil Chemical Company).

Purified waste gas 638 is then compressed in a gas compressor 640 to produce a compressed waste gas 642, which can be partially recycled back (effluent 644) to partial oxidation unit 620 and/or directly sent to water-gas shift unit 646, wherein CO can be shifted in presence of steam 648, to produce shift gas 650 comprising hydrogen and carbon dioxide.

Method 600 further comprises: separating the carbon dioxide and the hydrogen from shift gas 650 in carbon capture unit 652 to produce carbon dioxide-enriched effluent 654 and effluent 664 comprising a hydrogen- and nitrogen-enriched mixture. Carbon capture unit 652 can be a conventional amine or solvent absorption unit or other suitable adsorption technology.

Carbon dioxide-enriched effluent 654 can be sequestered, stored, used for EOR, or used for urea production. Urea 656 can be produced in a urea synthesis reactor 658 by reacting carbon dioxide-enriched effluent 654 with ammonia 660. Ammonia can be produced in ammonia reactor 662 using the hydrogen- and nitrogen-enriched mixture of effluent 664. Optionally, a stream of H₂ 666 may be injected into ammonia reactor 662 to enhance ammonia production.

As will be apparent to those skilled in the art, the methods 600 illustrated in this non-limiting example and related systems may include additional components like compressors (which can be multi-stage), membranes, valves, flow meters, heat exchangers, traps, and the like for proper and safe operation of said methods and systems.

Embodiments disclosed herein include:

A. Methods for reducing carbon emissions from waste gas produced from partial oxidation, such as syngas produced from a FLEXICOKING™ process. The methods comprise: introducing a first effluent and a second effluent in a gasifier of a partial oxidation unit to produce a waste gas, wherein the first effluent comprises one or more hydrocarbon containing feeds and the second effluent comprises air, enriched air with oxygen or oxygen; selectively removing hydrogen sulfide (H₂S) from the waste gas; combining the waste gas and steam in a water-gas shift unit to produce a shift gas comprising hydrogen and carbon dioxide; separating the carbon dioxide from the shift gas in a carbon capture unit to produce a carbon dioxide-enriched effluent and an effluent comprising a hydrogen- and nitrogen-enriched mixture; and recovering the carbon dioxide from the carbon dioxide-enriched effluent.

B. A facility for reducing carbon emissions from waste gas produced from partial oxidation comprise: at least one partial oxidation unit comprising one or more gasifiers configured for producing a waste gas and heat from one or more feeds, in presence of air and/or oxygen; a water-gas shift unit configured to receive the waste gas and steam for producing a shift gas comprising hydrogen and carbon dioxide; a carbon capture unit configured to receive the shift gas for at least partially removing the carbon dioxide from the shift gas and for producing a carbon dioxide-enriched gas and an effluent comprising a hydrogen- and nitrogen-enriched mixture.

Embodiments A and B may have one or more of the following additional elements in any combination:

Element 1: wherein the one or more feeds comprise a gas selected from the group consisting of: CO; hydrogen; methane; carbon dioxide; carbonyl sulfide; hydrogen sulfide; water; nitrogen; biomass; plastics; petroleum coke; coal; resid; C₁-C₄ hydrocarbons; and any combination thereof

Element 2: wherein the waste gas comprises a gas selected from the group consisting of: hydrogen; carbon monoxide; carbon dioxide; nitrogen; and any combination thereof.

Element 3: wherein partial oxidation is a catalytic process, a non-catalytic process, or a heat-based process.

Element 4: wherein partial oxidation is a Flexicoking process.

Element 5: wherein the waste gas is a syngas FLEXIGAS™

Element 6: removing particulate matters using a water wash and/or an interstage compressor water condensation.

Element 7: wherein selectively removing hydrogen sulfide is performed using Compact Mass transfer and Inline Separation Technology (cMIST™), SELEXOL® process, FLEXSORB® SE solvents technology, and any combination thereof.

Element 8: at least partially removing nitrogen from the air of the second effluent.

Element 9: removing carbon dioxide from the shift gas to produce a hydrogen-enriched shift gas.

Element 10: wherein removing carbon dioxide from the shift gas is performed using two different separation technologies in series as a two-step process.

Element 11: wherein water-gas shift reaction is performed in the presence of a catalyst.

Element 12: wherein the catalyst is a transition metal catalyst selected from the group consisting of: iron oxide, CoMo, zinc oxide, aluminum oxide, and any combination thereof

Element 13: wherein heat recovered from the partial oxidation unit is used to generate steam for the water-gas shift reaction and/or carbon dioxide removal.

Element 14: wherein the water-gas shift reaction is carried out at a temperature from about 190° C. to about 425° C.

Element 15: wherein output products from the water-gas shift unit has a hydrogen content from about 30 vol % to about 80 vol %.

Element 16: wherein output products from the water-gas shift unit has a carbon dioxide content from about 5 vol % to about 30 vol %.

Element 17: wherein recovering carbon dioxide is carried out by passing the carbon dioxide-enriched effluent through an absorbent system.

Element 18: wherein the carbon capture unit is an amine unit.

Element 19: wherein the absorbent system is an amine absorbent system selected from the group consisting of: piperazines, ethanolamines, and any combination thereof

Element 20: wherein the carbon dioxide-enriched effluent has a carbon dioxide content of about 50 vol % or greater.

Element 21: wherein the carbon dioxide-enriched effluent has a carbon dioxide content of at least about 85 vol %.

Element 22: recovering H₂ from the effluent comprising a hydrogen- and nitrogen-enriched mixture.

Element 23: converting the effluent comprising the hydrogen- and nitrogen-enriched mixture into one or more of ammonia, urea, or any combination thereof.

Element 24: wherein converting the effluent comprising the hydrogen- and nitrogen-enriched mixture into ammonia comprises: increasing hydrogen concentration to about 3:1 relative to nitrogen.

Element 25: wherein increasing hydrogen concentration in the waste gas from the gasifier of the partial oxidation unit comprises: maximizing steam injection into the gasifier; introducing methane to the gasifier for steam reforming; shifting carbon monoxide in the water-gas shift unit to hydrogen and carbon dioxide; and at least partially removing any excess of nitrogen either from the air of the second effluent or from the waste gas downstream of the water-gas shift unit and carbon dioxide recovery; and recycling at least a portion of the waste gas back to the gasifier.

Element 26: at least partially or entirely removing nitrogen from the air of the second effluent in the gasifier of the partial oxidation unit to produce an hydrogen-enriched waste gas; shifting a portion of carbon monoxide of the hydrogen-enriched waste gas in the water-gas shift unit to hydrogen and carbon dioxide; and recovering carbon dioxide to produce methanol or its derivatives.

Element 27: wherein water-gas shift reaction and carbon dioxide removal from the shift gas are performed in series or simultaneously.

Element 28: wherein the second effluent only comprises an oxygen-enriched feed.

Element 29: wherein the gasifier of the partial oxidation unit is configured to increase to the production of hydrogen per coke burned.

Element 30: processing the effluent comprising the hydrogen- and nitrogen-enriched mixture in one or more refinery fuel gas headers, wherein the effluent can optionally be combined with one or more fuel gases.

Element 31: producing a second waste gas effluent and heat from a second partial oxidation unit upstream of the water-gas shift unit.

Element 32: combining the second waste gas effluent with the waste gas produced from partial oxidation of the first effluent and the second effluent; and generating steam from the heat, wherein the steam is introduced to the water-gas shift unit, and/or the carbon capture unit.

Element 33: wherein the water-gas shift unit and the carbon capture unit are replaced by a Sorption Enhanced Water-Gas Shift unit.

Element 34: wherein the water-gas shift unit and the carbon capture unit are replaced by a carbonate fuel cell operated “in reverse” with power supplied to produce a low pressure (about 3 bara or less) product mixture comprising hydrogen and nitrogen.

Element 35: wherein the facility further comprising a second partial oxidation unit is configured for producing a second waste gas effluent and heat, wherein the heat is used for generating steam.

Element 36: the water-gas shift unit and the carbon capture unit are replaced by a carbonate fuel cell operated “in reverse” with power supplied to produce a low pressure (about 3 bara or less) product mixture comprising hydrogen and nitrogen.

Element 37: wherein the water-gas shift unit and the carbon capture unit are replaced by a Sorption Enhanced Water-Gas Shift unit.

Element 38: wherein the mixture of hydrogen and nitrogen is converted into one or more of: ammonia, urea, methanol, dimethyl ether, or any combination thereof.

Element 39: an ammonia reactor configured to receive the hydrogen and the nitrogen for producing ammonia.

Element 40: a urea synthesis reactor configured to receive ammonia and carbon dioxide for producing urea.

Element 41: a Compact Mass transfer and Inline Separation Technology (cMIST™) treating unit, SELEXOL® treating unit, and/or a FLEXSORB® SE Tail Gas Treating Unit for hydrogen sulfide removal.

By way of non-limiting example, exemplary combinations applicable to A include, but are not limited to: 1 or 2, and 3; 1 or 2, and 4; 1 or 2, and 5; 1 or 2, and 6; 1 or 2, and 6 and 7; 1 or 2, and 7; 1 or 2, and 8; 1 or 2, and 6-8; 1 or 2, and 7 and 8; 1 or 2, and 9; 1 or 2, and 6-9; 1 or 2, and 11; 1 or 2, and 13; 1 or 2, and 13 and 14; 1 or 2, and 16; 13 and 14; 13 and 15; and 13 and 16; 18 or 19, and 20; 18 or 19, and 21; 18 or 19, and 22; 18 or 19, and 23; 18 or 19, and 23 and 24; 18 or 19, and 26; 21 or 22, and 23; 21 or 22, and 23 and 24; 23 and 25; and 23 and 26.

By way of non-limiting example, exemplary combinations applicable to B include, but is are not limited to: 35 or 36, and 37; 35 or 36, and 38; 35 or 36, and 39; 35 or 36, and 40; 35 or 36, and 41; 35 or 36, and 40 and 41; 35 or 36, and 37 and 38; 39 and 40.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present disclosure is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
introducing a first effluent and a second effluent in a gasifier of a partial oxidation unit to produce a waste gas, wherein the first effluent comprises one or more hydrocarbon containing feeds and the second effluent comprises air, enriched air with oxygen or oxygen;
selectively removing hydrogen sulfide (H₂S) from the waste gas;
combining the waste gas and steam in a water-gas shift unit to produce a shift gas comprising hydrogen and carbon dioxide;
separating the carbon dioxide from the shift gas in a carbon capture unit to produce a carbon dioxide-enriched effluent and an effluent comprising a hydrogen- and nitrogen-enriched mixture; and
recovering the carbon dioxide from the carbon dioxide-enriched effluent.

2. The method of claim 1, wherein the waste gas comprises a gas selected from the group consisting of: hydrogen; carbon monoxide; carbon dioxide; nitrogen; and any combination thereof.

3. The method of claim 1, wherein partial oxidation is a Flexicoking process.

4. The method of claim 1, wherein the waste gas is a syngas FLEXIGAS™

5. The method of claim 1, further comprising:
removing particulate matters using a water wash and/or an interstage compressor water condensation and at least partially; removing nitrogen from the air of the second effluent and removing carbon dioxide from the shift gas to produce a hydrogen-enriched shift gas.

6. The method of claim 5, wherein removing carbon dioxide from the shift gas is performed using two different separation technologies in series as a two-step process.

7. The method of claim 1, wherein heat recovered from the partial oxidation unit is used to generate steam for the water-gas shift reaction and/or carbon dioxide removal.

8. The method of claim 1, wherein output products from the water-gas shift unit has a hydrogen content from about 30 vol % to about 80 vol %.

9. The method of claim 1, wherein output products from the water-gas shift unit has a carbon dioxide content from about 5 vol % to about 30 vol %.

10. The method of claim 1, wherein recovering carbon dioxide is carried out by passing the carbon dioxide-enriched effluent through an absorbent system.

11. The method of claim 10, wherein the absorbent system is an amine absorbent system selected from the group consisting of: piperazines, ethanolamines, and any combination thereof

12. The method of claim 1, wherein the carbon dioxide-enriched effluent has a carbon dioxide content of about 50 vol % or greater.

13. The method of claim 5, further comprising:
recovering H₂ from the effluent comprising a hydrogen- and nitrogen-enriched mixture.

14. The method of claim 13, wherein converting the effluent comprising the hydrogen- and nitrogen-enriched mixture into ammonia comprises:
increasing hydrogen concentration to about 3:1 relative to nitrogen.

15. The method of claim 1, further comprising:
at least partially or entirely removing nitrogen from the air of the second effluent in the gasifier of the partial oxidation unit to produce an hydrogen-enriched waste gas;
shifting a portion of carbon monoxide of the hydrogen-enriched waste gas in the water-gas shift unit to hydrogen and carbon dioxide; and
recovering carbon dioxide to produce methanol or its derivatives.

16. The method of claim 13, further comprising:
processing the effluent comprising the hydrogen- and nitrogen-enriched mixture in one or more refinery fuel gas headers, wherein the effluent can optionally be combined with one or more fuel gases.

17. The method of claim 1, further comprising:
producing a second waste gas effluent and heat from a second partial oxidation unit upstream of the water-gas shift unit.

18. The method of claim 17, further comprising:
combining the second waste gas effluent with the waste gas produced from partial oxidation of the first effluent and the second effluent; and
generating steam from the heat, wherein the steam is introduced to the water-gas shift unit, and/or the carbon capture unit.

19. The method of claim 1, wherein the water-gas shift unit and the carbon capture unit are replaced by a carbonate fuel cell operated “in reverse” with power supplied to produce a low pressure (about 3 bara or less) product mixture comprising hydrogen and nitrogen.

20. A facility for reducing carbon emissions from waste gas produced from partial oxidation comprising:
at least one partial oxidation unit comprising one or more gasifiers configured for producing a waste gas and heat from one or more feeds, in presence of air and/or oxygen;
a water-gas shift unit configured to receive the waste gas and steam for producing a shift gas comprising hydrogen and carbon dioxide;
a carbon capture unit configured to receive the shift gas for at least partially removing the carbon dioxide from the shift gas and for producing a carbon dioxide-enriched gas and an effluent comprising a hydrogen- and nitrogen-enriched mixture.
